(19) United States
(12) Patent Application Publication
(10) Pub. No.: US 2013/0027686 A1
(43) Pub. Date: Jan. 31, 2013

(54) Analysis Device and Method

(71) Applicants: Bruno BALLUCH, Wien (AT); Walter Smetana, Wien (AT); Ibrahim Atassi, Wien (AT); Gottfried Koehler, Pressbaum (AT); Michael Edetsberger, Wien (AT)

(72) Inventors: Bruno BALLUCH, Wien (AT); Walter Smetana, Wien (AT); Ibrahim Atassi, Wien (AT); Gottfried Koehler, Pressbaum (AT); Michael Edetsberger, Wien (AT)

(21) Appl. No.: 13/500,708

(22) PCT Filed: Oct. 7, 2010
(86) PCT No.: PCT/AT2010/000374

§ 371 Date: Oct. 4, 2012

(30) Foreign Application Priority Data
Oct. 7, 2009 (AT) A 1582/2009

(51) Int. Cl. G01J 3/28

(52) U.S. Cl. 356/72; 356/402

(57) ABSTRACT

An analysis device, having a sample container unit (1) comprising: a sample container (2) for receiving a substantially liquid sample and marking the particles contained in the sample, having a cap (3) for fluid-tight closure of the sample container (2); a measuring cell unit (4), which is in fluidic communication with the sample container (2) via an outlet (43), which measuring cell unit has a liquid-conducting channel (49), at least one wall of which channel is embodied as at least partially transparent; a carrier unit (10), which has means for contactlessly transporting and/or concentrating marked particles contained in the sample fluid; and an optical unit (20) for spectroscopic and/or microscopic detection of the marked particles, having at least one light source (19, 21) for excitation of the marked particles in the sample.

The invention relates to an analysis device for quantitative and/or qualitative analysis of particles in a substantially liquid sample, and to a method for performing the analysis using the aforementioned device.

It is known to analyze particles, such as cells, in liquids by fluorescence spectroscopy. Hereinafter, the term “particles” includes biological cells of varying origin or optionally solids or molecules. For the analysis, liquid samples are mixed with a dye, such as individual proteomic markers that accumulate on the particles in the sample. It is also known to use these methods for performing the detection and quantification of tumor cells in various body fluids, such as urine. The known methods have the disadvantages that they take longer than 50 minutes until a prepared sample preparation is ready, and that they require many individual work steps, which only skilled persons can perform. Moreover, it is necessary to use the most various kinds of equipment, whose operation again requires specially trained personnel.

The object of the invention is to create both an analysis device and a method which make it possible to shorten the analysis time, compared to known methods, for quantitative and qualitative detection of predetermined particles in a liquid and thus to make them more economical. A further object is to make the analysis capable of being done simply and reliably and to make the outcome visually perceptible.

These objects are attained by an analysis device of the invention, having a sample container unit comprising a sample container for receiving a liquid sample and marking the particles contained in the sample, having a cap for fluid-tight closure of the sample container; a measuring cell unit, which is in fluidic communication with the sample container via an outlet, which measuring cell unit has a liquid-conducting channel, at least one wall of which channel is embodied as at least partially transparent; a carrier unit, which has means for contactlessly transporting and/or concentrating marked particles contained in the sample fluid; and having an optical unit for spectroscopic and/or microscopic detection of the marked particles, having at least one light source for excitation of the marked particles in the sample.

The method of the invention for analysis of a substantially liquid sample having particles that are freely movable in it includes the steps of a) marking the particles with a dye and/or magnetic agents; b) spatially bundling the marked particles, optionally by generating a magnetic field for spatially bundling magnetically sensitive particles and/or sedimentation; and c) performing a spectroscopic and/or microscopic analysis of the particles contained in the sample.

The present invention, with a brief incubation time of 5 to 10 minutes, makes high accuracy possible; that is, a sensitivity and selectivity of >95%, in particular even in a disease in its early stage.

The analysis device of the invention has a compact construction with short fluid channels, so that only tiny volumes of agents and sample fluids are needed, as a result of which, among other advantages, the costs of analysis can be lowered.

In particular, the analysis device of the invention and the method performed with this analysis device enable fast, objectified computer-supported detection of particles that have been altered by disease, especially in body fluids, such as urine or sputum, but also particles in blood as well as tissue cell suspensions. Both the analysis device of the invention and the method of the invention can advantageously be employed for cytological detection of cancer diseases, for checking for doping, or for counting particles and bacteria.

A preferred embodiment is distinguished in that the cap of the sample container is formed from an outer screw-on cap part and a middle cap part connected to the outer cap part via a rated breaking point, and the outer diameter of the middle cap part is approximately equivalent to the inner diameter of the sample container, so that the middle cap part can be lowered into the sample container in form-locking fashion.

A further preferred embodiment is distinguished in that the middle cap part includes an inner cap part that can be moved into the middle cap part, and between the underside of the inner cap part and a foil extending between the lower edge of the middle cap part, a hollow space for receiving the agents for marking the particles is embodied in the sample.

A further preferred embodiment is distinguished in that prestressed elements, which preferably dip into the sample in the tripped state, are additionally provided in the hollow space.

A further preferred embodiment is distinguished in that valves are disposed at the entrance and the exit of the liquid-conducting channel.

A further preferred embodiment is distinguished in that a mixing chamber is disposed between the entrance of the liquid-conducting channel and the spectroscopic and/or microscopic observation chamber.

A further preferred embodiment is distinguished in that a filter is disposed in the liquid-conducting channel on the outlet end of the spectroscopic and/or microscopic observation chamber.

A further preferred embodiment is distinguished in that the sample container unit and the carrier unit are detachably connected to one another.

A further preferred embodiment is distinguished in that the sample container unit can be connected selectively to the carrier unit in terms of orientation by means of shaped elements, and the carrier unit has complementary component means.

A further preferred embodiment is distinguished in that the shaped elements are embodied as a set of at least two holes having different inner diameters.

A further preferred embodiment is distinguished in that the light source is formed by at least one monochromatic LED and that the light is conducted to the spectroscopic and/or microscopic observation chamber by means of an optical waveguide integrated with the carrier unit.

A further preferred embodiment is distinguished in that the carrier unit has at least one coil system for generating magnetic fields, by means of which fields magnetically sensitive particles in the sample can be spatially bundled or distributed.

A further preferred embodiment is distinguished in that the carrier unit further has at least one temperature sensor and at least one heating element for heating the sample upstream and/or downstream of the analysis site.

A further preferred embodiment is distinguished in that the carrier unit has a liquid-conducting channel.

Finally, a further preferred embodiment is distinguished in that the carrier unit has sensors for ascertaining further parameters of the sample.

A further preferred embodiment of the method is distinguished in that after the analysis of the sample, it includes the following step: backflushing both the particulate component and the sample fluid, followed by a cleaning solution, into the sample container and/or disinfecting the carrier unit.

The invention will be explained in further detail below in terms of exemplary embodiments shown in the drawings. In the drawings:

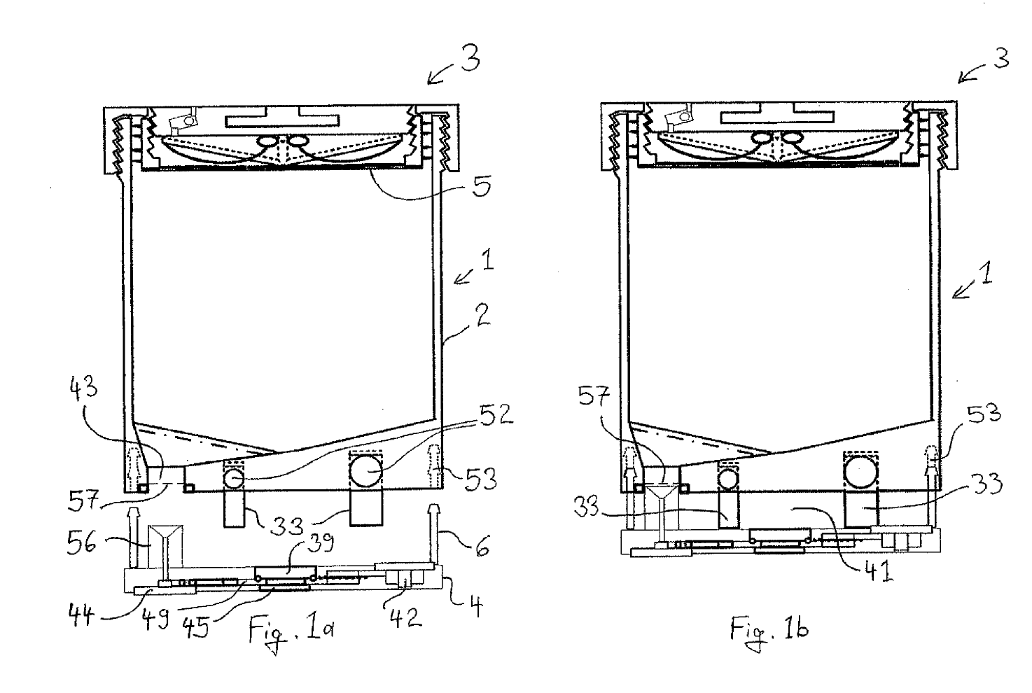

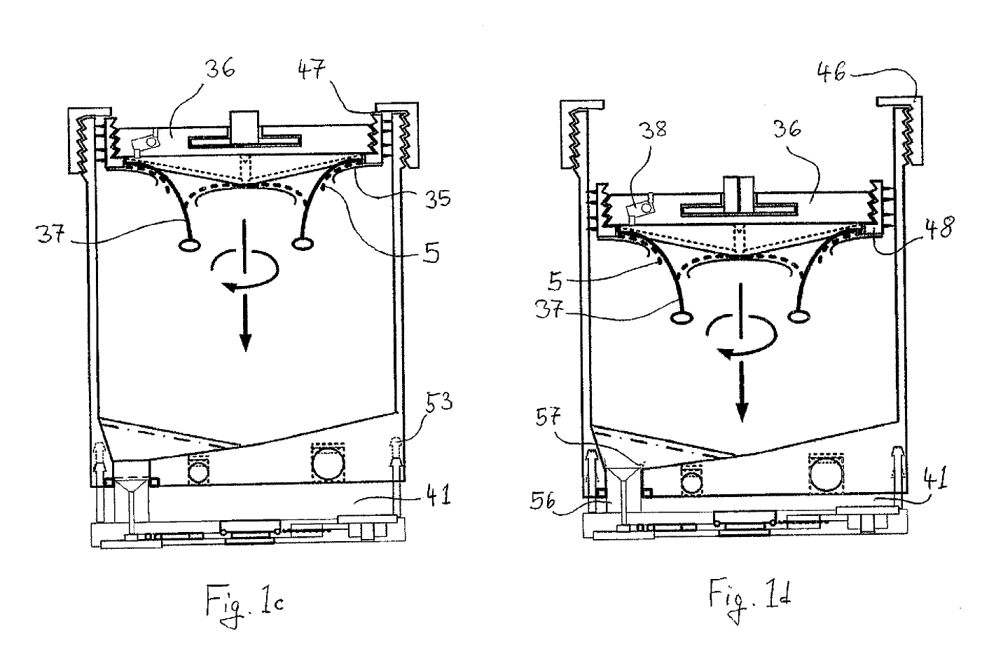

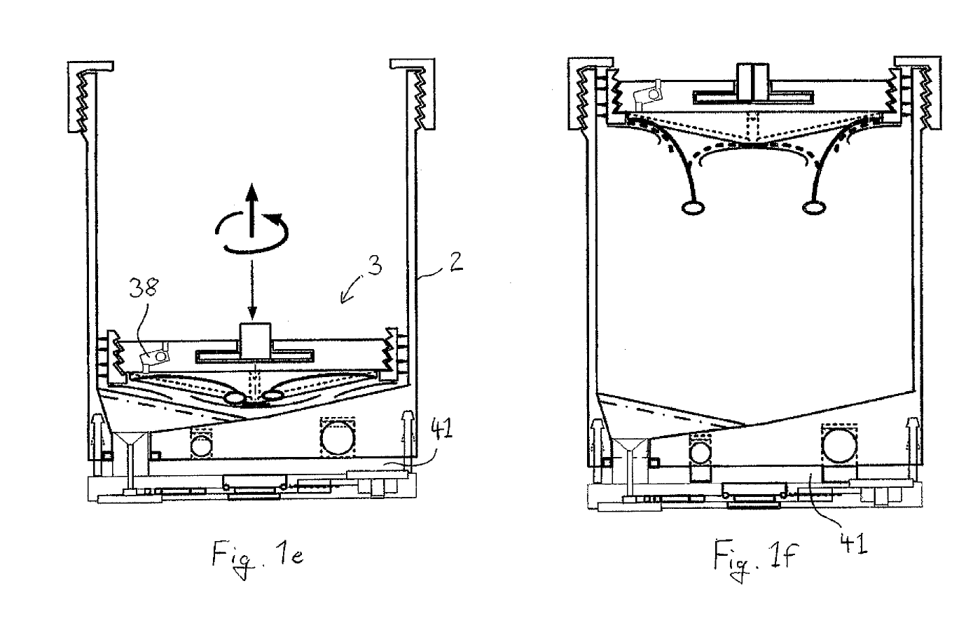

FIGS. 1a-1f show a longitudinal section through a sample container unit, comprising a sample container with a cap and a measuring cell unit, in various stages of the analysis method;

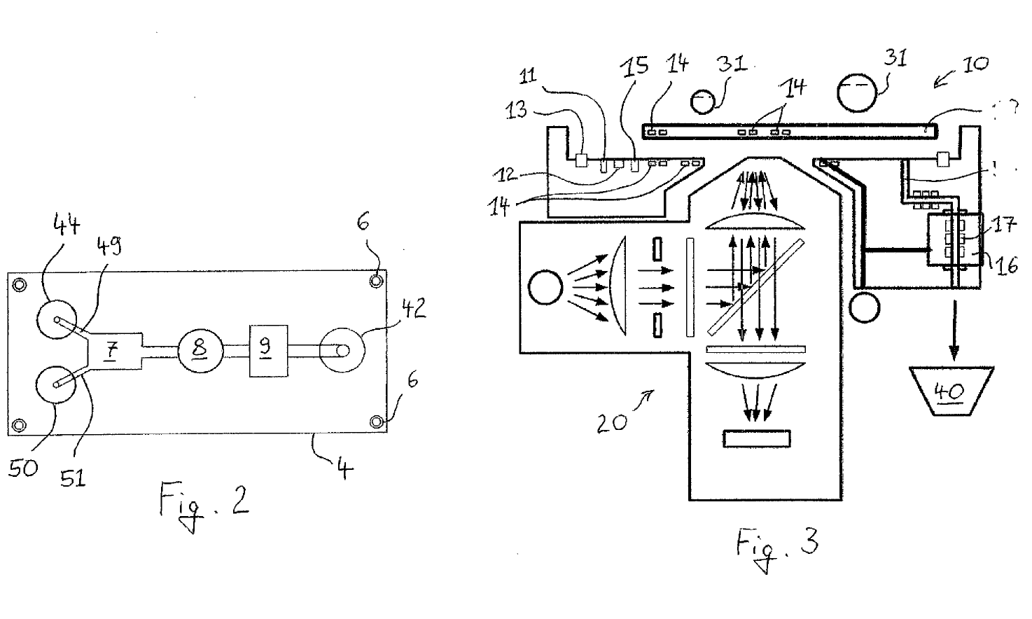

FIG. 2 shows a schematic cross-sectional view of a measuring cell unit;

FIG. 3 shows a schematic elevation view of a combination of a carrier unit and an optical unit;

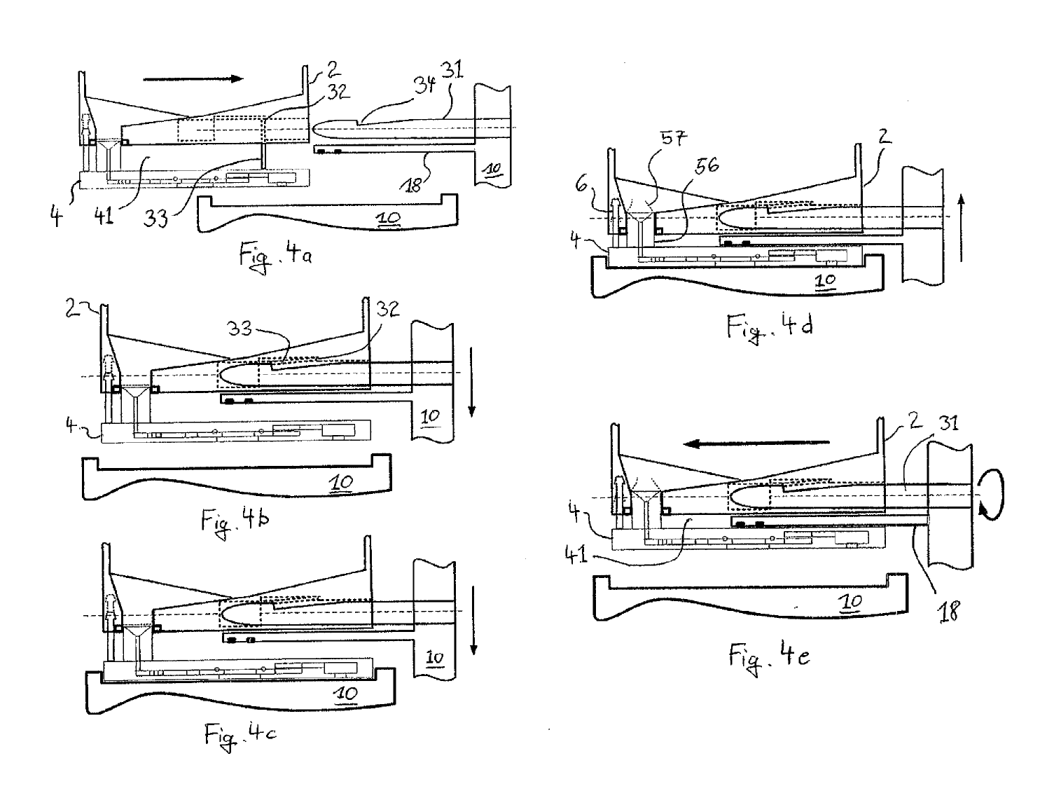

FIGS. 4a-4e show a schematic view of a plug connection; and

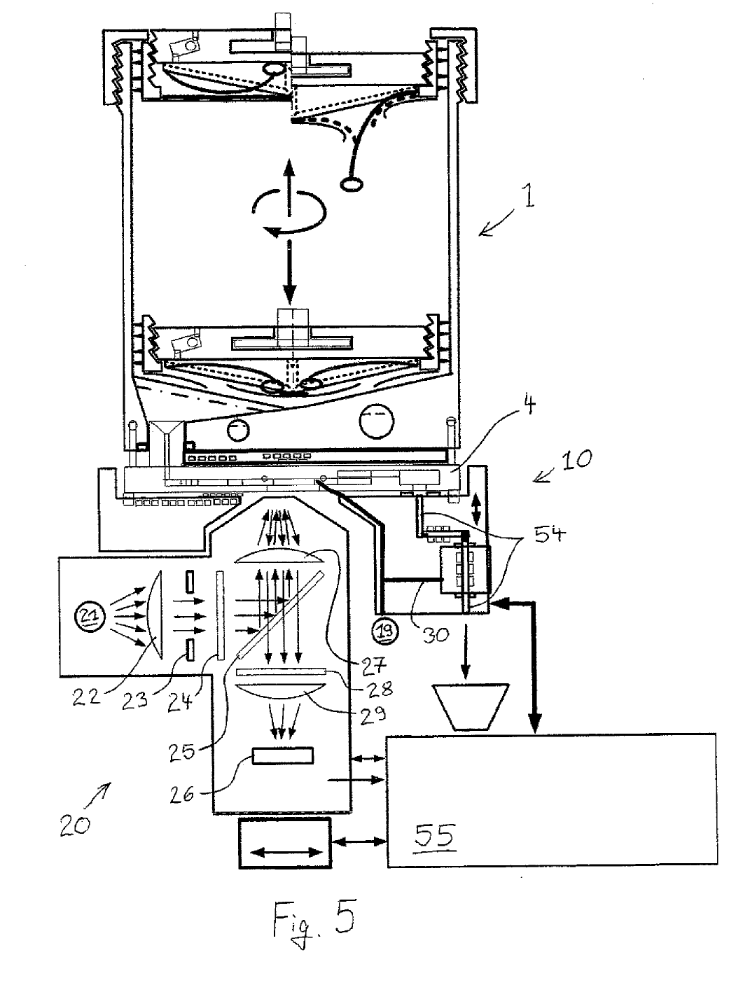

FIG. 5 shows a schematic view of the analysis device.

A first function part of the analysis device is the sample container unit 1 shown in FIG. 1a, which essentially comprises three function groups: a sample container 2, a cap 3, and the measuring cell unit 4, shown separately, which can be connected to the container bottom, for instance by being snapped onto it.

The function of the sample container 2 is to receive the substantially liquid sample to be examined, in particular during the marking of the particles contained in it. In its bottom the sample container has an outlet 43, through which the sample, from the sample container 2, reaches the inside of the measuring cell unit 4 for analysis.

Depending on the analysis task desired, the agents 5 required for the analysis, such as a dye, and/or magnetic beads, can be placed, protected against environmental factors and aging, in the cap 3 of the sample container 2, optionally in chambers separated in sectors from one another and if desired in sealed fashion. Insert elements (not shown) can be placed in the sample container in form-locking fashion and serve the purpose of prefiltration, for example, to prevent clogging of the outlet 43 to the measuring cell unit 4 by coarse contaminants (kidney stone fragments, tissue scrapings from surgical operations), and/or serve as a repository for additional agents. Alternatively to the insert elements, plug-in elements (not shown) having the same function can be connected externally to the container bottom in form-locking, non-detachable, and fluid-tight fashion via connecting pins 6. These plug-in elements, as adaptor pieces (adaptors) can enable a connection between modified forms of the measuring cell unit 4 and the sample container.

Via the connecting pins 6, the measuring cell unit 4 shown in FIG. 2 is connected to the sample container bottom via holes 53 with two snap-in positions, and a fluidic communication between the outlet 43 and a liquid-conducting channel 49 provided in the measuring cell unit is established and, depending on the analysis task, includes functional components for cellular analysis, which are disposed along the liquid-conducting channel 49. These components are, among others, a mixing chamber 7, a spectroscopic and/or microscopic observation chamber 8 which optionally serves the purpose of sedimentation, and a filter 9 for filtering particles. The measuring cell unit 4 furthermore has valves 42 and 44, in order to control the flow of the sample during the analysis. A transparent window 45 is located on the bottom of the observation chamber 8, in order to enable examining the sample spectroscopically and/or microscopically, preferably by fluorescence spectroscopy and/or fluorescence microscopy.

The sample container unit 1 is preferably embodied as a disposable plastic part. In that case, each sample requires its own sample container unit. Its component parts perform microfluidic functions for separating out the particles present in the fluid, but preferable do not include any sensors. The particulate portion of the sample always remains inside the measuring cell unit 4 of the sample container unit 1 before, during, and also after the analysis and once the analysis has been done can be disposed of properly along with the sample container unit.

Before the sample container unit 1 is inserted into a carrier unit 10 (FIGS. 3 and 5), the fluidic communication between the sample container 2 and the measuring cell unit 4 connected to it, for instance by means of a seal, remains closed.

A further function part of the analysis device is the carrier unit 10, shown in FIGS. 3 and 5, on which the sample container unit 1 is mounted. It serves above all as a carrier of components which, in cooperation with the measuring cell unit 4, support fluorescence spectroscopic and/or fluorescence microscopic analysis of the particulate portion of the sample, by controlling the transportation, concentration, and ambient conditions of the particles that are to be determined. To that end, depending on the embodiment, such components as temperature sensors 11, flow sensors 12 for ascertaining flow rates, coil systems 14 for generating magnetic fields, electromechanical or pneumatic transducers for valves of the measuring cell unit 4, and elements for cooling or tempering the measuring cell unit 4 and the coil system 14 are integrated.

Particularly for analysis of more-complex body fluids that contain many different particles, selective separation of target cells in the observation chamber is required, since in such cases, simple sedimentation by gravity is inadequate. The cell precipitation can be accomplished or reinforced in field-induced fashion, for instance by means of magnetic fields. To that end, the carrier unit preferably has controllable coil systems 14. These coil systems 14, disposed in an array, can be switched on and off arbitrarily, and as a result, not only magnetic alternating fields for controlled mixing but also fields for immobilizing particles with magnetic beads adhering to them can be generated.

Advantageously, the controllable coil systems 14 are disposed both above and below the measuring cell unit 4 of the sample container unit 1. To that end, between the sample container unit 1 and the measuring cell unit 4 attached to it, a recess 41 is provided, which receives a crosspiece 18 of the carrier unit 10, in which crosspiece coil systems 14 are provided. This crosspiece 18 of the carrier unit 10 can optionally be integrated as a module with the analysis device, to reinforce the sedimentation of the cells or particles.

The carrier unit 10 is preferably designed for continuous operation. Preferably, ceramic multi-layer circuitry, which is known to the person skilled in the art, is employed. As a result, the coil systems 14 shown in FIGS. 3 and 5 can for instance be produced in integrated fashion, with currents of up to 10 amperes flowing through them, thus making stronger magnetic forces on the order of magnitude of nanonewtons available for controlling the magnetically marked particles. Preferably, ferrite foils with a relative magnetic permeability of 100 to 400 in the linear range can be used, as a result of which the magnetic field can be focused into the sample medium in a targeted way.

By a suitable disposition of the components, the ceramic also allows the heat produced to be carried away. A tempering system in the form of heating elements 15 with temperatures sensors can also be integrated with the carrier unit 10, since as a result, the activity of the particles or cells is preserved, and the sensitivity of the entire analysis system can be enhanced. In regions of liquid-conducting channels 54, provided in the carrier unit 10, that are for carrying the sample fluids onward or diverting them, heating elements 15 can also be provided, to enable thermal sterilization of these channels.

Besides the aforementioned components of the carrier unit 10, in a selective analysis portion 16, further sensors 17 for determining additional parameters, such as the liquid portions of the sample, and for determining its pH value, ammonia content and/or protein content can be variably integrated with the carrier unit 10.

A further function part of the analysis device is an optical unit 20, of the kind shown in FIGS. 3 and 5. It serves to detect the marked target cells in the measuring cell unit 4 and selectively to excite the marked target cells. To that end, the optical unit 20, of conventional design, comprises an LED 21 as an excitation source, a collimator 22 for making the radiation parallel, a diaphragm 23, an excitation filter 24, a dichroic beam splitter 25 that reflects waves of the excitation frequency and allows waves of the emission frequency to pass in the direction of a camera 26, a microscopic lens 27, an emission filter 28, a plane-convex collecting lens 29, and finally a suitable camera 26. This optical function group can be assembled from standard components. The further assessment can be done with computer support, for which purpose a suitable electronic device 55 is provided.

Alternatively, however, the excitation can also be done by means of an optically narrow-band-emitting, preferably monochromatic LED 19 via an optical waveguide 30 via the carrier unit 10 lighting controlled by a special index of refraction, as also shown in FIG. 3.

Below, the measuring method using the analysis device of the invention will be explained in further detail, again in junction with the drawings. At the beginning, as shown in FIG. 1b, there is a sample container unit 1, provided with the sample and having a closed cap 3 and a measuring cell unit 4 mounted on it. A seal 57 is still closed, and the measuring cell unit is spaced apart from the container bottom by spring tongues 33. Next, as shown in FIG. 1c, an inner cap part 36 is screwed into a middle cap part 47, as a result of which a foil 35 opens and the agents 5 drop into the sample and incubate it.

For performing the measuring method, the sample container unit 1, in a mistake-proof or selective-orientation position as shown in FIGS. 4a-4e and 5, is pushed onto complementary component means 31, which are more or less in the form of load-bearing guide pins of the carrier unit 10. In FIGS. 4a-4e, the complementary component means 31 are shown in cross section, and as the sample container unit is being pushed on, they engage opposed shaped elements 52, in the form of holes in the sample container 2. As shown in FIG. 4b, pushing the sample container unit on causes kinking of rated kink zones 32 of those spring tongues 33 which, as spacers, prevent an unintended fluidic communication between the measuring cell unit 4, placed on the bottom of the container, and the sample container 2. Once the sample container unit has been pushed on, the sample container 2 cannot be removed until the end of the measurement procedure as shown in FIGS. 4c and 4d. The complementary component means 31 with a wedge-shaped recess 34, combined with the kinked spring tongues 33 on the container bottom, prevent the sample container 2, for instance by means of barbs, from coming loose. The complementary component means 31 are embodied as rotatable about their longitudinal axis, as shown in FIG. 4e.

Once the incubation has been initiated, the complementary component means 31, on which the sample container 1 is locked, are lowered along with the upper part of the carrier unit 10, as shown in FIGS. 4c and 4d. As a result, the measuring cell unit 4, which as the first part of the sample container unit 1 is firmly seated on the carrier unit 10, is subsequently pressed against both the upper carrier unit 10 and the container bottom 1, so that as shown in FIG. 4d, the transition piece 56 of the measuring cell unit 4 pierces the seal 47 of the container bottom (see also FIG. 1d). The connection made between the sample container 2 and the measuring cell unit 4 by the connecting pins 6 then snaps into place inseparably. By pressing the measuring cell unit 4 against the lower carrier unit 10 or additionally by switching the valve 42, a fluidic communication between the outlet of the measuring cell unit 4 and the inlet to the carrier unit 10 is simultaneously opened. As the middle cap part 48, functioning as a ram, and the inner cap part 36 move inward, the sample fluid is mechanically pressed into the measuring cell unit 4.

During the measurement procedure, the sample container 2 takes on the function of a perfusion cartridge. The cap 3 as shown in FIG. 1d acts as a ram. To that end, it is constructed of an outer cap part 46 and a middle cap part 48, which as shown in FIGS. 1a-1c are joined together via a rated breaking point 47. First, via a perfusor spindle drive, an inner cap part 36 is screwed in until it meets a stop; this opens the sealed foil 35. In the sample container 2, the sample fluid is incubated with the dye 5 and if needed with the magnetic beads. From this phase on, via barbs, the middle cap part 48 and the inner cap part 36 are secured in fluid-tight fashion against being screwed open again. Screwing them in any farther causes the rated breaking point 47 to break and now lowers the inner cap part 36 and the middle cap part 48 together as a ram, as shown in FIG. 1d.

The agents 5 are contained, for instance in solid form, in the cap 3, or optionally are applied two-dimensionally to the foil 35, or a in the form of a coating of mixed beads. Alternatively, prestressed elements 37, for instance of plastic, that are concealed in the interior of the cap unfold spontaneously when the foil breaks and reinforce the mixing of the agents 5 and the sample fluid. A special geometry of the inside of the cap, in the form of bucket flaps or interference flaps (not shown), can further promote mixing as the cap 3, as a ram, is moved farther inward in rotating fashion. Any residual air still present in the container 2 can escape through an exhaust valve 38 in the cap 3, which however does not allow any fluid to escape. After the analysis, backflushing the sample into the sample container 2 is optionally done, by means of tensile stress on the cap 3, as shown in FIG. 1e. The exhaust valve 38 closes, for example by a valve ram or float body that snaps into a detent.

After the inner cap part 36 has been screwed/pushed in, it preferably snaps into a detent in the middle cap part 48 such that the two can no longer be separated from one another even in response to tensile stress, for instance while the sample is being backflushed.

During the measurement procedure, the incubated sample fluid reaches the mixing chamber 7 of the measuring cell unit 4. Here, further agents are delivered as needed via an optional second inlet 51 that can connected into the measuring cell unit 4, as shown in FIG. 2. The delivery is controlled in turn by a valve 50. The ensuing mixing is done by a combined process, either fluidically by means of barriers or baffles (not shown) integrated with the mixing chamber 7 and/or the observation chamber 8 in the case of an adapted control of the flow rate, or in field-induced fashion by means of controllable coil systems 14, which are located in the carrier unit 10 positioned above and below the measuring cell unit.

The thus-marked and mixed sample flows to the observation chamber 8, where the particles thus marked by color and optionally also magnetically settle out or are collected by means of a strong nonhomogeneous magnetic field, brought about for example by neodymium magnets (not shown) or by the coil system 14. After the magnetic field is shut off, the particles can likewise settle out freely. Alternatively, with the field kept in force, the particles can be concentrated by slow mechanically/pneumatically induced lowering of an observation chamber cap 39, made of soft plastic that is kept dark in color, which suppresses interfering background reflections.

The measuring cell unit 4 contains a filter 9 for separating out further particles. Premature closure of the filter membrane of the filter 9 from clogging or occlusion can be detected from a pressure increase in the measuring cell unit and suppressed by means of backflushing pulses, on the one hand orthogonally through the filter membrane and on the other on the prefilter side tangentially along the filter membrane by means of an addition channel unit, not shown, with a valve. It is equally possible, after they have flowed through the entire volume of the sample, for those particles which settle out in the vicinity of the filter chamber to be backflushed in the direction of the observation chamber by means of such a tangential countercurrent. The sample fluid can if desired be subjected to further analyses in an analysis portion 16 and is finally collected in a waste unit 40 for disposal. Alternatively, the sample fluid can be backflushed into the sample container 2 in the course of the disinfection of the analysis device. To achieve this, after the analysis, the particulate portion of the sample, along with the sample fluid, followed by a cleaning solution, is backflushed into the sample container, and the carrier unit 10 is disinfected; after being removed, the closed sample container 2 can be harmlessly disposed of properly. Mechanically, this can be done for instance as shown in FIG. 4e by rotating the complementary component means 31, embodied as guide pins, and therefore undoing the locking, and the sample container 1 can be removed.

The method and the components of the measuring cell unit 4, the carrier unit 10, and the optical unit 20 are preferably controlled via an electronic device 55, such as a computer. The qualitative and/or quantitative analysis of the marked particles or cells is preferably likewise done with computer support.

It is understood that the exemplary embodiments described can be modified in various ways within the scope of the concept of the invention, for instance with regard to the materials used and the geometrical embodiment of channels and plug connections, without departing from the scope of the invention.

List of Reference Numerals

| | |
|---|---|
| 1 | Sample container unit |
| 2 | Sample container |
| 3 | Cap |
| 4 | Measuring cell unit |
| 5 | Dye/agents |
| 6 | Connecting pins |
| 7 | Mixing chamber |
| 8 | Observation chamber |
| 9 | Filter |
| 10 | Carrier unit |
| 11 | Temperature sensors |
| 12 | Flow sensors |
| 13 | Piezoelectric actuators |
| 14 | Coil systems |
| 15 | Heating elements |
| 16 | Selective analysis portion |
| 17 | Sensors |
| 18 | Crosspiece |
| 19 | Monochromatic LED |
| 20 | Optical unit |
| 21 | LED |
| 22 | Collimator |
| 23 | Diaphragm |
| 24 | Excitation filter |
| 25 | Dichroic beam splitter |
| 26 | Camera |
| 27 | Microscopic lens |
| 28 | Emission filter |
| 29 | Plane-convex collecting lens |
| 30 | Optical waveguide |
| 31 | Complementary component means |
| 32 | Rated buckling zone |
| 33 | Spring tongues |
| 34 | Wedge-shaped recess |
| 35 | Foil |
| 36 | Inner cap part |
| 37 | Prestressed element |
| 38 | Exhaust valve |
| 39 | Observation chamber cap |
| 40 | Waste unit |
| 41 | Recess |
| 42 | Valve |
| 43 | Outflow |
| 44 | Valve |
| 45 | Transparent window |
| 46 | Outer cap part |
| 47 | Rated breaking point |
| 48 | Middle cap part |
| 49 | Liquid-conducting channel |
| 50 | Valve |
| 51 | Second inlet |
| 52 | Shaped element |
| 53 | Hole |
| 54 | Liquid-conducting channel |
| 55 | Transition piece |
| 57 | Seal |

1. An analysis device, having a sample container unit comprising:
a sample container for receiving a substantially liquid sample and marking particles contained in the sample, having a cap for fluid-tight closure of the sample container;
a measuring cell unit, which is in fluidic communication with the sample container via an outlet, which measuring cell unit has a liquid-conducting channel, at least one wall of which channel is embodied as at least partially transparent;
a carrier unit, which has means for contactlessly transporting and/or concentrating marked particles contained in the sample fluid; and
an optical unit for spectroscopic and/or microscopic detection of the marked particles, having at least one light source for excitation of the marked particles in the sample.

2. The analysis device according to claim 1, wherein the cap of the sample container is formed from an outer screw-on cap part and a middle cap part connected to the outer cap part via a rated breaking point, the outer diameter of the middle cap part being approximately equivalent to the inner diameter of the sample container, so that the middle cap part can be lowered into the sample container in form-locking fashion.

3. The analysis device according to claim 1, wherein the middle cap part includes an inner cap part that can be moved into the middle cap part, and between the underside of the inner cap part and a foil extending between the lower edge of the middle cap part, a hollow space for receiving the agents for marking the particles is embodied in the sample.

4. The analysis device according to claim 3, wherein prestressed elements, which dip into the sample in the tripped state, are additionally provided in the hollow space.

5. The analysis device according to claim 1, wherein valves are disposed at the entrance and the exit of the liquid-conducting channel.

6. The analysis device according to claim 1, wherein a mixing chamber is disposed between the entrance of the liquid-conducting channel and the spectroscopic and/or microscopic observation chamber.

7. The analysis device according to claim 1, wherein a filter is disposed in the liquid-conducting channel on the outlet end of the spectroscopic and/or microscopic observation chamber.

8. The analysis device according to claim 1, wherein the sample container unit and the carrier unit are detachably connected to one another.

9. The analysis device according to claim 8, wherein the sample container unit can be connected selectively, in terms of orientation, to the carrier unit by shaped elements, and the carrier unit has complementary component means.

10. The analysis device according to claim 9, wherein the shaped elements are embodied as a set of at least two holes having different inner diameters.

11. The analysis device according to claim 1, wherein the light source is formed by at least one monochromatic LED, and the light is conducted to the spectroscopic and/or microscopic observation chamber by an optical waveguide integrated with the carrier unit.

12. The analysis device according to claim 1, wherein the carrier unit has at least one coil system for generating magnetic fields configured to spatially bundle or distribute magnetically sensitive particles in the sample.

13. The analysis device according to claim 1, wherein the carrier unit further has at least one temperature sensor and heating elements for heating the sample upstream and/or downstream of the analysis site.

14. The analysis device according to claim 1, wherein the carrier unit has a liquid-conducting channel.

15. The analysis device according to claim 1, wherein the carrier unit has sensors for ascertaining further parameters of the sample.

16. A method for analysis of a substantially liquid sample having particles that are freely movable therein, comprising the steps of:
a) marking the particles with a dye and/or magnetic agents;
b) spatially bundling the marked particles fluid-mechanically with barriers or baffles and/or by generating a magnetic field for spatially bundling magnetically sensitive particles and/or sedimentation; and
c) performing a spectroscopic and/or microscopic analysis of the particles contained in the sample.

17. The method according to claim 16, which after the analysis of the sample includes the following step:
backflushing both the particulate component and the sample fluid, followed by a cleaning solution, into the sample container and/or disinfecting the carrier unit.
